(19) United States
(12) Patent Application Publication
(10) Pub. No.: US 2026/0243329 A1
(43) Pub. Date: Aug. 20, 2026

(54) RECIPROCATING INTERNAL COMBUSTION ENGINE

(71) Applicant: AISIN CORPORATION, Kariya (JP)

(72) Inventor: Hiroshi ISONO, Kariya-shi (JP)

(73) Assignee: AISIN CORPORATION, Kariya (JP)

(21) Appl. No.: 19/539,966

(22) Filed: Feb. 13, 2026

(30) Foreign Application Priority Data
Feb. 17, 2025 (JP) 2025-023492

(51) Int. Cl. F16H 1/32; B60K 6/387; B60K 6/547; F02B 75/18; F16H 1/28

(52) U.S. Cl. CPC F16H 1/32; B60K 6/387; B60K 6/547; F02B 75/1896; F16H 1/28

(57) ABSTRACT

Provided is a reciprocating internal combustion engine allowing generated vibration to be easily reduced. The reciprocating internal combustion engine includes a first piston member, a first planetary gear mechanism, a first counterrotating member, a second piston member, a second planetary gear mechanism, a second counterrotating member, an interlocking mechanism, and an output member. The first piston member is connected to the first counterrotating member through the first planetary gear mechanism. The second piston member is connected to the second counterrotating member through the second planetary gear mechanism. The interlocking mechanism causes the first counterrotating member and the second counterrotating member to interlock with each other in such a way that the members rotate at the same speed. The output member rotates in interlocking relation with a rotating member rotating in interlocking relation with a rotating member constituting the interlocking mechanism.

### CROSS REFERENCE TO RELATED APPLICATIONS

This application is based on and claims priority under 35 U.S.C. § 119 to Japanese Patent Application 2025-023492, filed on Feb. 17, 2025, the entire content of which is incorporated herein by reference.

### TECHNICAL FIELD

This disclosure generally relates to a reciprocating internal combustion engine.

### BACKGROUND DISCUSSION

A known technique related to a reciprocating internal combustion engine is disclosed in, for example, WO2013/047878A1 (Reference 1). In the following background discussion, reference signs and names in Reference 1 are cited in parentheses.

Reference 1 discloses a reciprocating internal combustion engine (an opposed-piston engine A) including a cylinder (a horizontal cylinder 1), and a first piston member (a left piston 2) and a second piston member (a right piston 3) that reciprocate within the cylinder (the horizontal cylinder 1). The reciprocating internal combustion engine (the opposed-piston engine A) disclosed in Reference 1 reduces vibration to be generated by reciprocating motion of the first piston member (the left piston 2) and the second piston member (the right piston 3) by employing an opposed-type configuration in which the first piston member (the left piston 2) and the second piston member (the right piston 3) reciprocate within the same cylinder (the horizontal cylinder 1).

However, the reciprocating internal combustion engine (the opposed-piston engine A) disclosed in Reference 1 converts the reciprocating motion of the first piston member (the left piston 2) and the second piston member (the right piston 3) into rotary motion by a crank mechanism (left and right crank mechanisms 17 and 18) and therefore tends to cause secondary vibration.

A need thus exists for a reciprocating internal combustion engine which is not susceptible to the drawback mentioned above.

### SUMMARY

According to an aspect of this disclosure, a reciprocating internal combustion engine includes: a first planetary gear mechanism including a first ring gear being an internal gear, a first carrier being rotatably supported relative to the first ring gear, and a first planetary gear being rotatably supported relative to the first carrier and engaging with the first ring gear; a first crank member being connected to the first planetary gear in such a way as to rotate integrally with the first planetary gear; a first piston member being connected to the first crank member in such a way as to be rotatable relative to the first crank member around a first input shaft center being set at a position separated from a first planetary shaft center being a rotating shaft center of the first planetary gear; a first counterrotating member rotating in the opposite direction to the first carrier at the same speed in interlocking relation with rotation of the first carrier; a second planetary gear mechanism including a second ring gear being an internal gear, a second carrier being rotatably supported relative to the second ring gear, and a second planetary gear being rotatably supported relative to the second carrier and engaging with the second ring gear; a second crank member being connected to the second planetary gear in such a way as to rotate integrally with the second planetary gear; a second piston member being connected to the second crank member in such a way as to be rotatable relative to the second crank member around a second input shaft center being set at a position separated from a second planetary shaft center being a rotating shaft center of the second planetary gear; a second counterrotating member rotating in the opposite direction to the second carrier at the same speed in interlocking relation with rotation of the second carrier; an interlocking mechanism causing the first counterrotating member and the second counterrotating member to interlock with each other in such a way that the first counterrotating member and the second counterrotating member rotate at the same speed; and an output member rotating in interlocking relation with the first carrier, the second carrier, the first counterrotating member, the second counterrotating member, and the interlocking mechanism.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view of a reciprocating internal combustion engine according to Embodiment 1;

FIG. 2 is a cross-sectional view taken along a line II-II in FIG. 1;

FIG. 3 is a cross-sectional view taken along a line III-III in FIG. 1;

FIG. 4 is a cross-sectional view of a reciprocating internal combustion engine according to Embodiment 2;

FIG. 5 is a cross-sectional view taken along a line V-V in FIG. 4;

FIG. 6 is a cross-sectional view taken along a line VI-VI in FIG. 4;

FIG. 7 is a cross-sectional view of a reciprocating internal combustion engine according to Embodiment 3;

FIG. 8 is a cross-sectional view of a reciprocating internal combustion engine according to Embodiment 4;

FIG. 9 is a cross-sectional view taken along a line IX-IX in FIG. 8;

FIG. 10 is a cross-sectional view taken along a line X-X in FIG. 8;

FIG. 11 is a cross-sectional view of a reciprocating internal combustion engine according to Embodiment 5;

FIG. 12 is a cross-sectional view taken along a line XII-XII in FIG. 11;

FIG. 13 is a cross-sectional view of a reciprocating internal combustion engine according to Embodiment 6; and

FIG. 14 is a cross-sectional view taken along a line XIV-XIV in FIG. 13.

### DETAILED DESCRIPTION

### Embodiment 1

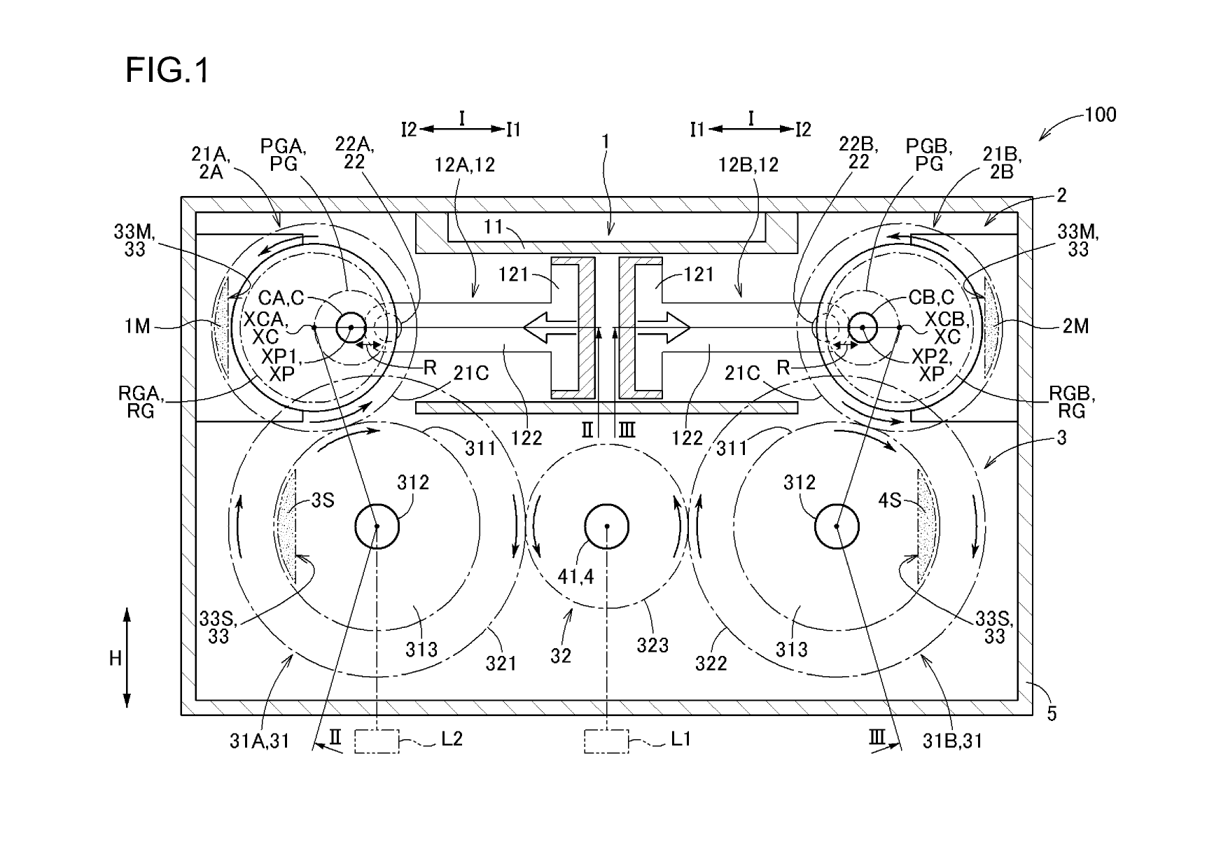

A reciprocating internal combustion engine 100 according to Embodiment 1 is described with reference to FIGS. 1 to 3.

The reciprocating internal combustion engine 100 is an engine serving as a driving source for a rotating machine driven by rotational power, such as a generator, a pump, or the like. Specifically, the reciprocating internal combustion engine 100 converts energy contained in a combustion gas generated in a combustion chamber into reciprocating motion. Then, the reciprocating internal combustion engine 100 converts the reciprocating motion into rotary motion and outputs the rotary motion.

The reciprocating internal combustion engine 100 includes a reciprocating unit 1, a power conversion unit 2, an output member 4, a vibration reduction structure 3, and a case 5 housing the aforementioned components, as illustrated in FIG. 1. The reciprocating unit 1 converts the energy contained in the combustion gas into reciprocating motion. The power conversion unit 2 converts the reciprocating motion acquired from the combustion gas by the reciprocating unit 1 into rotary motion. The output member 4 is used for outputting the rotary motion.

The reciprocating unit 1 includes a cylinder 11 forming a combustion chamber in which air mixed with fuel burns and a piston member 12 reciprocating in the cylinder. The cylinder 11 is a tubular container including a wall surrounding the outer periphery of the combustion chamber, and the piston member 12 is a member covering the combustion chamber from the side. Although not illustrated, at least an intake port for supplying air into the combustion chamber, an exhaust port for discharging air containing combustion gas out of the combustion chamber, and an injector for mixing air and fuel are disposed around the combustion chamber.

The piston member 12 reciprocates along the longitudinal direction of the cylinder 11 to perform processes of a combustion cycle including a process of drawing air into the combustion chamber, a process of burning a gas acquired by mixing fuel and air, and a process of exhausting the burned gas from the combustion chamber. A detailed structure of the reciprocating unit 1 is easier to understand when described on the basis of a direction in which the piston member 12 reciprocates, and therefore, the direction in which the piston member 12 reciprocates is herein referred to as a reciprocating direction I. In the reciprocating direction I, a side closer to the combustion chamber is referred to as a reciprocating-direction inner side I1, and a side farther from the combustion chamber is referred to as a reciprocating-direction outer side I2. Further, a direction perpendicular to the reciprocating direction I is referred to as a cylinder radial direction H.

The piston member 12 includes a piston body 121 constituting a wall covering the combustion chamber from the side and a connecting rod 122 connecting the piston body 121 to the power conversion unit 2.

The piston body 121 moves between a top dead center and a bottom dead center within the cylinder 11. The top dead center is the innermost position on the reciprocating-direction inner side I1 in an area where the piston body 121 can move within the cylinder. On the other hand, the bottom dead center is the outermost position on the reciprocating-direction outer side I2 in the area where the piston body 121 can move within the cylinder. The specific positions of the top dead center and the bottom dead center are determined by the shape of the connecting rod 122 and the structure of the power conversion unit 2. The piston body 121 moves from the top dead center to the bottom dead center as a surface disposed on the reciprocating-direction inner side I1 receives the expansion pressure of the combustion gas and moves from the bottom dead center to the top dead center as the air in the combustion chamber is discharged out of the combustion chamber through the exhaust port. The piston member 12 is disposed at the top dead center in the example illustrated in FIG. 1.

The connecting rod 122 is a member extending along the reciprocating direction I. An end of the connecting rod 122 on the reciprocating-direction inner side I1 is connected to a portion of the piston body 121 on the reciprocating-direction outer side I2, and an end of the connecting rod 122 on the reciprocating-direction outer side I2 is connected to the power conversion unit 2. The power conversion unit 2 converts the reciprocating motion transmitted from the piston body 121 through the connecting rod 122 into rotary motion. In this embodiment, the connecting rod 122 includes a pair of connecting portions 123 on both sides in a direction orthogonal to the reciprocating direction I. Each of the pair of connecting portions 123 extends along the reciprocating direction I, and an end of each connecting portion on the reciprocating-direction outer side I2 is connected to the power conversion unit 2.

In this embodiment, the power conversion unit 2 includes a planetary gear mechanism 21 for outputting rotary motion to the output member 4, and a crank member 22 connecting the planetary gear mechanism 21 to the connecting rod 122.

The planetary gear mechanism 21 includes a ring gear RG which is an internal gear, a carrier C rotatably supported relative to the ring gear RG, and a planetary gear PG being rotatably supported relative to the carrier C and engaging with the ring gear RG. The reciprocating motion of the piston body 121 is transmitted to the planetary gear PG through the connecting rod 122 and the crank member 22 and is output as rotary motion by the carrier C. In this embodiment, the carrier C includes an output portion 21C outputting rotary motion. As an example of the output portion 21C, FIG. 1 illustrates an external gear rotating together with the carrier C.

The ring gear RG is disposed on the reciprocating-direction outer side I2 relative to the cylinder 11. In this embodiment, the ring gear RG is disposed in such a way that the shaft center of the ring gear RG overlaps with the center position of the cylinder 11 in the cylinder radial direction H when viewed in the reciprocating direction I. The planetary gear PG is movably supported by the carrier C along the inner circumference of the ring gear RG while engaging with the ring gear RG. Therefore, the carrier C includes a rotating shaft center (a carrier shaft center XC) overlapping with the shaft center of the ring gear RG and rotates around the carrier shaft center XC in interlocking relation with the movement of the planetary gear PG along the inner peripheral surface of the ring gear RG.

The planetary gear mechanism 21 outputs rotary motion from the carrier C, and therefore, the arrangement relationship between the planetary gear mechanism 21 and the crank member 22 and the arrangement relationship between the planetary gear mechanism 21 and the vibration reduction structure 3 can be more easily understood on the basis of the carrier shaft center XC. Then, a direction along the carrier shaft center XC is herein referred to as an axial direction X. Then, one side in the axial direction X is referred to as a first axial side X1, and the other side in the axial direction X is referred to as a second axial side X2.

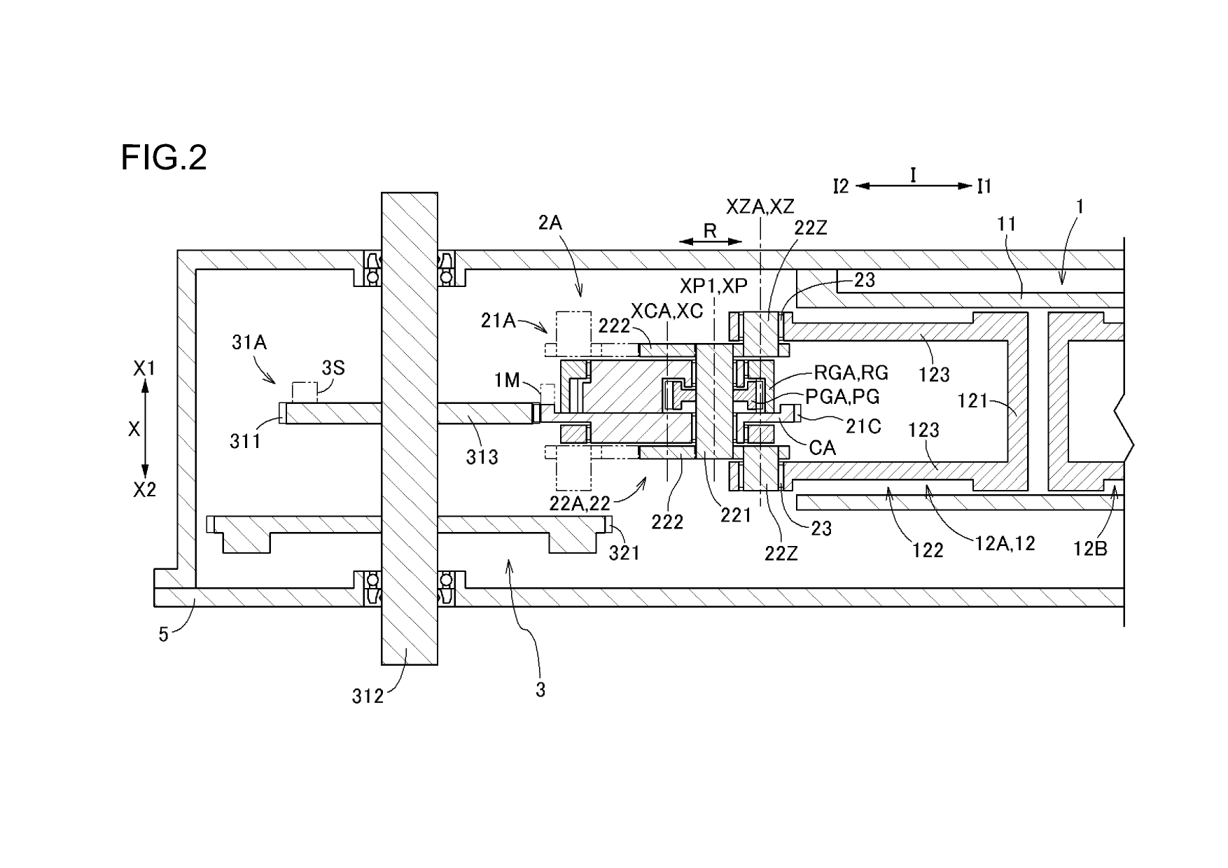

The crank member 22 is connected to the planetary gear PG in such a way as to rotate integrally with the planetary gear PG, as illustrated in FIG. 2. The crank member 22 includes a planetary shaft 221 supporting the planetary gear PG, an input shaft 22Z to which reciprocating motion is input, and an arm 222 connecting the input shaft 22Z to the planetary shaft 221 in such a way that the arm prevents relative movement. The input shaft 22Z includes a shaft center (an input shaft center XZ) extending in the axial direction X and is rotatably supported by the connecting portion 123 through a connecting bearing 23. The planetary shaft 221 rotates together with the planetary gear PG and has the same rotating shaft center as the shaft center of the planetary gear PG (a planetary shaft center XP).

The piston member 12 is connected to the crank member 22 in such a way as to be relatively rotatable around the input shaft center XZ set at a position separated from the planetary shaft center XP. In this embodiment, the input shaft center XZ is disposed at a position separated from the planetary shaft center XP in a planetary radial direction R which is a direction orthogonal to the planetary shaft 221. In this embodiment, the planetary shaft 221 is disposed in such a way that the planetary shaft center XP is positioned in a relationship parallel to the input shaft center XZ. In order to achieve such a positional relationship, the arm 222 is configured as a member extending in the reciprocating direction I and the cylinder radial direction H. In the example illustrated in FIG. 2, the input shaft 22Z and the planetary shaft 221 are fixed to the arm 222 in such a way that the shafts protrude in mutually opposite directions along the axial direction X.

In this embodiment, the crank member 22 includes a pair of input shafts 22Z arranged with a spacing in the axial direction X and a pair of arms 222. One of the pair of input shafts 22Z is connected to one of the pair of connecting portions 123, and the other of the pair of input shafts 22Z is connected to the other of the pair of connecting portions 123. Then, one end of the planetary shaft 221 on the first axial side X1 is fixed to one of the pair of arms 222, and an end on the second axial side X2 is fixed to the other of the pair of arms 222. According to this configuration, the planetary gear mechanism 21 can be disposed at a position overlapping with the piston body 121 when viewed in the reciprocating direction I, and therefore, a load biased in the axial direction X is less likely to be applied to the connection structure between the planetary gear mechanism 21 and the connecting rod 122, and the surrounding structure thereof.

When the piston body 121 reciprocates in the cylinder 11, the input shaft 22Z traces a linear path along the reciprocating direction I in such a way as to reciprocate within a certain range. Consequently, the arm 222 and the planetary shaft 221 rotate relative to each other around the input shaft center XZ moving along the reciprocating direction I, which causes the entire crank member 22 to revolve around the shaft center of the ring gear RG together with the planetary gear PG. According to this configuration, the difference between the speed variation when the piston body 121 moves from the bottom dead center to the top dead center and the speed variation when the piston body 121 moves from the top dead center to the bottom dead center is reduced.

The reciprocating unit 1 described above includes a pair of piston members 12, and the reciprocating internal combustion engine 100 includes a pair of power conversion units 2 respectively connected to the pair of piston members 12. Then, one of the pair of piston members 12 is herein referred to as a first piston member 12A, and the other of the pair of piston members 12 is referred to as a second piston member 12B. Further, one of the pair of power conversion units 2 is referred to as a first power conversion unit 2A, and the other of the pair of power conversion units 2 is referred to as a second power conversion unit 2B.

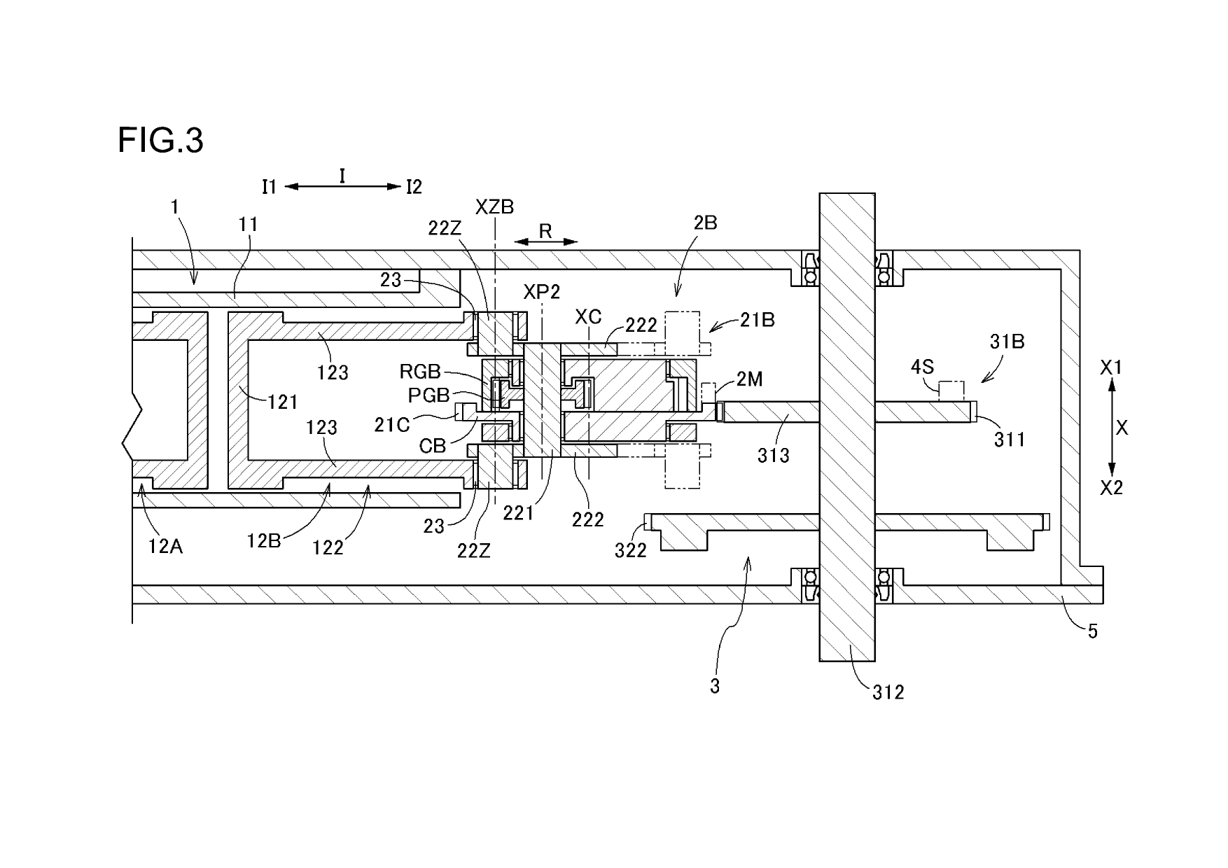

The first piston member 12A is connected to the first power conversion unit 2A, as illustrated in FIG. 2. The second piston member 12B is connected to the second power conversion unit 2B, as illustrated in FIG. 3.

The crank member 22 and the planetary gear mechanism 21 that are included in the first power conversion unit 2A are herein referred to as a first crank member 22A and a first planetary gear mechanism 21A, respectively, and the input shaft center XZ in the first crank member 22A is referred to as a first input shaft center XZA. The ring gear RG, the carrier C, and the planetary gear PG that are included in the first planetary gear mechanism 21A are referred to as a first ring gear RGA, a first carrier CA, and a first planetary gear PGA, respectively. A first rotating shaft center which is the carrier shaft center of the first carrier CA is referred to as a first carrier shaft center XCA, and the planetary shaft center XP of the first planetary gear PGA is referred to as a first planetary shaft center XP1.

Similarly, the crank member 22 and the planetary gear mechanism 21 that are included in the second power conversion unit 2B are referred to as a second crank member 22B and a second planetary gear mechanism 21B, respectively, and the input shaft center XZ of the second crank member 22B is referred to as a second input shaft center XZB. The ring gear RG, the carrier C, and the planetary gear PG that are included in the second gear mechanism are referred to as a second ring gear RGB, a second carrier CB, and a second planetary gear PGB, respectively. A second rotating shaft center which is the carrier shaft center XC of the second carrier CB is referred to as a second carrier shaft center XCB, and the planetary shaft center XP of the second planetary gear PGB is referred to as a second planetary shaft center XP2.

The axial direction X has been described to be defined on the basis of the carrier shaft center XC. Then, since a pair of carriers C exists in this embodiment, the axial direction X is preferably distinguished in correspondence with the pair of carrier shaft centers XC. However, as will be described later, the first carrier shaft center XCA and the second carrier shaft center XCB are positioned in a relationship parallel to each other in this embodiment, and therefore, the axial direction X is herein defined as a direction along the first carrier shaft center XCA and the second carrier shaft center XCB.

In this embodiment, the reciprocating unit 1 has an opposed-type configuration in which a pair of piston members 12 is arranged at positions facing each other, as illustrated in FIG. 1. Specifically, both the first piston member 12A and the second piston member 12B slide within the same cylinder 11. The cylinder 11 includes openings at both ends along the reciprocating direction I in order to arrange a pair of piston members 12 opposite to each other. The first piston member 12A is disposed at one of the openings of the cylinder 11, and the second piston member 12B is disposed at the other opening of the cylinder 11. Accordingly, the combustion chamber is surrounded by the wall of the cylinder 11, the piston body 121 of the first piston member 12A, and the piston body 121 of the second piston member 12B.

In this embodiment, since the reciprocating unit 1 is of the opposed type, the first power conversion unit 2A and the second power conversion unit 2B are arranged opposite to each other with the first piston member 12A and the second piston member 12B in between in terms of vibration reduction and structure simplification. The first carrier shaft center XCA which is the carrier shaft center XC of the first carrier CA and the second carrier shaft center XCB which is the carrier shaft center XC of the second carrier CB are arranged parallel to each other. Specifically, the first piston member 12A and the second piston member 12B are arranged opposite to each other in such a way as to reciprocate along a reference axis. The reference axis is an imaginary line connecting the first carrier shaft center XCA and the second carrier shaft center XCB viewed in the axial direction X.

The vibration reduction structure 3 includes a counterrotating member 31 and an interlocking mechanism 32, as illustrated in FIG. 1. The counterrotating member 31 and the interlocking mechanism 32 reduce primary vibration generated by the reciprocating piston member 12 during each reciprocating cycle. In this embodiment, the vibration reduction structure 3 further includes a balancer 33. The balancer 33 further reduces the primary vibration reduced by the counterrotating member 31 and the interlocking mechanism 32 and reduces vibration caused by torque fluctuations generated in the piston member 12 during transitions between the processes in the combustion cycle.

The counterrotating member 31 rotates in interlocking relation with the rotation of the carrier C included in the planetary gear mechanism 21 at the same speed as the carrier C in the opposite direction. According to this configuration, the counterrotating member 31 offsets at least a part of the vibration components generated by the piston member 12.

In this embodiment, the counterrotating member 31 includes an input portion 311 to which rotation is transmitted from the output portion 21C of the carrier C, a countershaft 312 rotating together with the input portion 311, and a wheel 313 rotating together with the countershaft 312, as illustrated in FIGS. 1 and 2. In this embodiment, the input portion 311 is a gear engaging with the output portion 21C which is an external gear. The countershaft 312 includes a rotating shaft center parallel to the carrier shaft center XC and is rotatably supported by the case 5. In the examples illustrated in FIGS. 1 and 2, the input portion 311 and the countershaft 312 are formed integrally.

The wheel 313 is a rotating body offsetting primary vibration generated by the reciprocating unit 1 and the power conversion unit 2. The wheel 313 is a rotating body having the center of gravity at a position separated from the carrier shaft center XC when viewed in the axial direction X in such a way that the wheel offsets the primary vibration generated by the reciprocating unit 1 and the power conversion unit 2. Specifically, the wheel 313 is a rotating body having the same rotating shaft center as the countershaft 312 and is connected to the countershaft 312 in such a way as to rotate together with the countershaft 312. In the example illustrated in FIG. 2, the wheel 313 also serves as the input portion 311, and the input portion 311 is provided on the outer peripheral portion of the wheel 313.

The vibration reduction structure 3 includes a pair of counterrotating members 31 in order to reduce the vibration of each of the pair of piston members 12 and the pair of power conversion units 2. For convenience of description, one of the pair of counterrotating members 31 is hereinafter referred to as a first counterrotating member 31A, and the other of the pair of counterrotating members 31 is referred to as a second counterrotating member 31B. The first counterrotating member 31A rotates in interlocking relation with the rotation of the first carrier CA included in the first planetary gear mechanism 21A in the opposite direction to the first carrier CA at the same speed. On the other hand, the second counterrotating member 31B rotates in interlocking relation with the rotation of the second carrier CB included in the second planetary gear mechanism 21B in the opposite direction to the second carrier CB at the same speed.

The interlocking mechanism 32 causes the first counterrotating member 31A and the second counterrotating member 31B to interlock with each other in such a way that the first counterrotating member 31A and the second counterrotating member 31B rotate at the same speed, as illustrated in FIG. 1. According to this configuration, many of the vibration components of the primary vibration generated by the reciprocating motion of the first piston member 12A and the second piston member 12B can be effectively offset. In this embodiment, the interlocking mechanism 32 drive-connects the wheel 313 included in the first counterrotating member 31A to the wheel 313 included in the second counterrotating member 31B in such a way that both wheels rotate in the same direction at the same speed.

“Drive-connected” herein refers to a state in which two rotating elements are connected in such a way as to allow transmission of driving force. Then, the state includes a state in which the two rotating elements are connected in such a way as to rotate integrally or a state in which the two rotating elements are connected in such a way as to allow transmission of driving force through one or more transmission members. Examples of such a transmission member include various members transmitting rotation at the same speed or at a changed speed, such as a shaft, a gear mechanism, a belt, and a chain. Note that the examples of the transmission member may include engagement devices selectively transmitting rotation and driving force, such as a friction engagement device and a meshing engagement device.

In this embodiment, the interlocking mechanism 32 includes a first driven gear 321 provided on the first counterrotating member 31A as illustrated in FIG. 2, a second driven gear 322 provided on the second counterrotating member 31B as illustrated in FIG. 3, and a driving gear 323. The driving gear 323 is an external gear engaging with both the first driven gear 321 and the second driven gear 322. In this embodiment, the first driven gear 321 has the same rotating shaft center as the countershaft 312 included in the first counterrotating member 31A and is an external gear disposed on the second axial side X2 relative to the wheel 313 included in the first counterrotating member 31A. On the other hand, the second driven gear 322 has the same rotating shaft center as the countershaft 312 included in the second counterrotating member 31B and is an external gear disposed on the second axial side X2 relative to the wheel 313 included in the second counterrotating member 31B. The number of teeth and the pitch circle diameter of the second driven gear 322 are set to be the same as the number of teeth and the pitch circle diameter of the first driven gear 321.

The output member 4 rotates in interlocking relation with the first carrier CA, the second carrier CB, the first counterrotating member 31A, the second counterrotating member 31B, and the interlocking mechanism 32. Specifically, the output member 4 is connected to the first carrier CA, the second carrier CB, the first counterrotating member 31A, the second counterrotating member 31B, and the interlocking mechanism 32, or one of gears, shafts and other rotating members that rotate together with the above, in such a way that the output member 4 rotates integrally therewith. For example, one rotating member rotating in interlocking relation with another rotating member includes a gear, which is an example of the one rotating member, and another gear, which is an example of the another rotating member, rotating while engaging with each other. For example, a driving gear shaft 41 rotatably supporting the driving gear 323 within the case 5 rotates integrally with the output member 4.

The output member 4 is connected to a first load L1. The first load L1 converts rotary motion into a form suitable for the intended use. Examples of the first load L1 include a generator and a wheel. When the first load L1 is a generator, the output member 4 is drive-connected to the rotating shaft of the generator and generates electricity by rotating the rotating shaft. For example, when the first load L1 is a wheel, the output member 4 is drive-connected to the axle of the wheel and causes the vehicle to travel by rotating the axle. The moment of inertia of the rotating part of the first load L1 is preferably set in consideration of the primary vibration generated by the reciprocating unit 1 and the power conversion unit 2 that are in operation.

The balancer 33 is a mass body group offsetting the vibration components of primary vibration and torque fluctuations that are generated by the reciprocating motion of the piston member 12 within the cylinder 11. The mass body group encompasses the meaning of a plurality of mass bodies. Then, the mass body includes a member detachably attached to a rotating member and a part of the rotating member. The balancer 33 includes a main balancer 33M, a counterbalancer 33S, and a torque balancer 33T.

The main balancer 33M is a mass body rotating in the same direction as the carrier C included in the planetary gear mechanism 21. According to this configuration, at least a part of the vibration components of the primary vibration generated by the reciprocating motion of the piston member 12 can be offset. Specifically, the main balancer 33M includes a first balance weight 1M and a second balance weight 2M. The first balance weight 1M offsets at least a part of the vibration components of the primary vibration generated by the first piston member 12A. The second balance weight 2M offsets at least a part of the vibration components of the primary vibration generated by the second piston member 12B.

The first balance weight 1M is a mass body rotating in the same direction as the first carrier CA. In this embodiment, the first balance weight 1M is a mass body constituting a part of the first carrier CA. The first balance weight 1M illustrated in FIGS. 1 and 2 is integrally formed with the first carrier CA and is a portion protruding from the outer peripheral portion of the first carrier CA towards the first axial side X1. The position and the area occupied by the first balance weight 1M in the first carrier CA when viewed in the axial direction X are determined in such a way that the relationship with the surrounding structure is optimized and the center of gravity of the first balance weight 1M is optimally positioned for reducing the primary vibration.

The first balance weight 1M is disposed in such a way that the center of gravity position thereof is positioned on the opposite side of the first carrier shaft center XCA relative to the first planetary shaft center XP1 when viewed in the axial direction X. In FIG. 1, the first balance weight 1M is disposed in such a way that the center of gravity thereof, the first planetary shaft center XP1, and the first carrier shaft center XCA are arranged in a straight line when viewed in the axial direction X.

The second balance weight 2M is a mass body rotating in the same direction as the second carrier CB, similarly to the relationship between the first balance weight 1M and the first carrier CA. In this embodiment, the second balance weight 2M is a mass body constituting a part of the second carrier CB. The second balance weight 2M illustrated in FIGS. 1 and 3 is integrally formed with the second carrier CB and is a portion protruding from the outer peripheral portion of the second carrier CB towards the first axial side X1. The position and the area occupied by the second balance weight 2M in the second carrier CB when viewed in the axial direction X are determined in such a way that the relationship with the surrounding structure is optimized and the center of gravity of the second balance weight 2M is optimally positioned for reducing the primary vibration.

The second balance weight 2M is disposed in such a way that the center of gravity position thereof is positioned on the opposite side of the second carrier shaft center XCB relative to the second planetary shaft center XP2 when viewed in the axial direction X. In FIG. 1, the second balance weight 2M is disposed in such a way that the center of gravity thereof, the second planetary shaft center XP2, and the second carrier shaft center XCB are arranged in a straight line when viewed in the axial direction X.

The counterbalancer 33S is a mass body rotating in the same direction as the counterrotating member 31. According to this configuration, the piston member 12 can offset at least a part of the vibration components of the primary vibration in the cylinder radial direction H during reciprocating motion at an intermediate position between the top dead center and the bottom dead center. Specifically, the counterbalancer 33S includes a third balance weight 3S and a fourth balance weight 4S. The third balance weight 3S can offset at least a part of the vibration components of the primary vibration in the cylinder radial direction H generated by the first piston member 12A and the first planetary gear mechanism 21A. The fourth balance weight 4S can offset at least a part of the vibration components of the primary vibration in the cylinder radial direction H generated by the second piston member 12B and the second planetary gear mechanism 21B.

The third balance weight 3S is a mass body rotating in the same direction as the first counterrotating member 31A. In this embodiment, the third balance weight 3S is a mass body rotating together with the wheel 313 included in the first counterrotating member 31A. The third balance weight 3S illustrated in FIGS. 1 and 2 is integrally formed with the wheel 313 included in the first counterrotating member 31A and is a portion of the wheel 313 protruding from the outer peripheral portion thereof towards the first axial side X1. The position and the area occupied by the third balance weight 3S in the wheel 313 when viewed in the axial direction X are determined in such a way that the relationship with the surrounding structure is optimized and the center of gravity of the third balance weight 3S is optimally positioned for reducing the primary vibration.

The third balance weight 3S is positioned to be synchronized with the rotation of the first balance weight 1M. Specifically, while in a rotated state, the third balance weight 3S is disposed in such a way that a first inclination angle (not illustrated) determined by the center of gravity position of the third balance weight 3S is equal to a second inclination angle (not illustrated) determined by the center of gravity position of the first balance weight 1M. The first inclination angle is an angle formed, when viewed in the axial direction X, between a reference line along the reciprocating direction I passing through the rotating shaft center of the third balance weight 3S and an inclined line connecting the rotating shaft center to the center of gravity position of the third balance weight 3S. The second inclination angle is an angle formed, when viewed in the axial direction X, between a reference line along the reciprocating direction I passing through the rotating shaft center of the first balance weight 1M and an inclined line connecting the rotating shaft center to the center of gravity position of the first balance weight 1M.

The fourth balance weight 4S is a mass body rotating in the same direction as the second counterrotating member 31B, similarly to the relationship between the third balance weight 3S and the wheel 313 included in the first rotating member. In this embodiment, the fourth balance weight 4S is a mass body rotating together with the wheel 313 included in the second counterrotating member 31B. The fourth balance weight 4S illustrated in FIGS. 1 and 3 is integrally formed with the wheel 313 included in the second counterrotating member 31B and is a portion of the wheel 313 protruding from the outer peripheral portion thereof towards the first axial side X1. The position and the area occupied by the fourth balance weight 4S in the wheel 313 when viewed in the axial direction X are determined in such a way that the relationship with the surrounding structure is optimized and the center of gravity of the fourth balance weight 4S is optimally positioned for reducing the primary vibration.

The fourth balance weight 4S is positioned to be synchronized with the rotation of the second balance weight 2M. Specifically, while in a rotated state, the fourth balance weight 4S is disposed in such a way that a third inclination angle (not illustrated) determined by the center of gravity position of the fourth balance weight 4S is equal to a fourth inclination angle (not illustrated) determined by the center of gravity position of the second balance weight 2M. The third inclination angle is an angle formed, when viewed in the axial direction X, between a reference line along the reciprocating direction I passing through the rotating shaft center of the third balance weight 3S and an inclined line connecting the rotating shaft center to the center of gravity position of the third balance weight 3S, similarly to the aforementioned first inclination angle. The fourth inclination angle is an angle formed between a reference line along the reciprocating direction I passing through the rotating shaft center of the second balance weight 2M and an inclined line connecting the rotating shaft center to the center of gravity position of the second balance weight 2M, similarly to the aforementioned second inclination angle.

The torque balancer 33T is a fifth balance weight 5T or a second load L2 having the same moment of inertia as the first load L1.

The fifth balance weight 5T (not illustrated in this embodiment) is a mass body provided on a rotating member, similarly to the first balance weight 1M, the second balance weight 2M, the third balance weight 3S, and the fourth balance weight 4S. The second load L2 converts rotary motion into a form suitable for the intended use, similarly to the first load L1. Examples of the second load L2 include a generator and a wheel, similarly to the first load L1. In the example illustrated in FIG. 1, the torque balancer 33T is the second load L2.

The fifth balance weight 5T or the second load L2 rotates in the opposite direction to the output member 4. For example, when the driving gear shaft 41 rotates integrally with the output member 4, the fifth balance weight 5T is provided on a rotating member rotating in the opposite direction to the driving gear shaft 41. Examples of such a rotating member in this embodiment include the wheel 313, the first driven gear 321, and the second driven gear 322. Similarly, when the driving gear shaft 41 rotates integrally with the output member 4, the second load L2 is drive-connected to a rotating member rotating in the opposite direction to the driving gear shaft 41. Examples of the rotating member drive-connected to the second load L2 in this embodiment include the countershaft 312. In the example illustrated in FIG. 1, the second load L2 is drive-connected to the countershaft 312 included in the first counterrotating member 31A. The second load L2 preferably has the same configuration as the first load L1. For example, when the first load L1 is a generator, the second load L2 is preferably also a generator with the same moment of inertia as the first load L1. According to this configuration, the vibration caused by torque fluctuations generated in the reciprocating unit 1 can be efficiently reduced.

The reciprocating internal combustion engine 100 as described above generates secondary vibration at a frequency approximately twice that of the primary vibration by the reciprocating motion of the piston member 12, in addition to the primary vibration and vibration caused by torque fluctuations. The secondary vibration is likely to be generated when the difference between the speed of the piston member 12 moving from the top dead center to the bottom dead center and the speed of the piston member 12 moving from the bottom dead center to the top dead center is large.

In this embodiment, it is preferable that the pitch circle radius of the ring gear RG be the same as the pitch circle diameter of the planetary gear PG and that, when viewed in the axial direction, the length from the planetary shaft center XP in the crank member 22 to the input shaft center XZ be the same as the pitch circle radius of the planetary gear PG. According to this configuration, the difference between the speed of the piston member 12 moving from the top dead center to the bottom dead center and the speed of the piston member 12 moving from the bottom dead center to the top dead center can be minimized. Accordingly, the secondary vibration generated by the reciprocating internal combustion engine 100 can be reduced.

### Embodiment 2

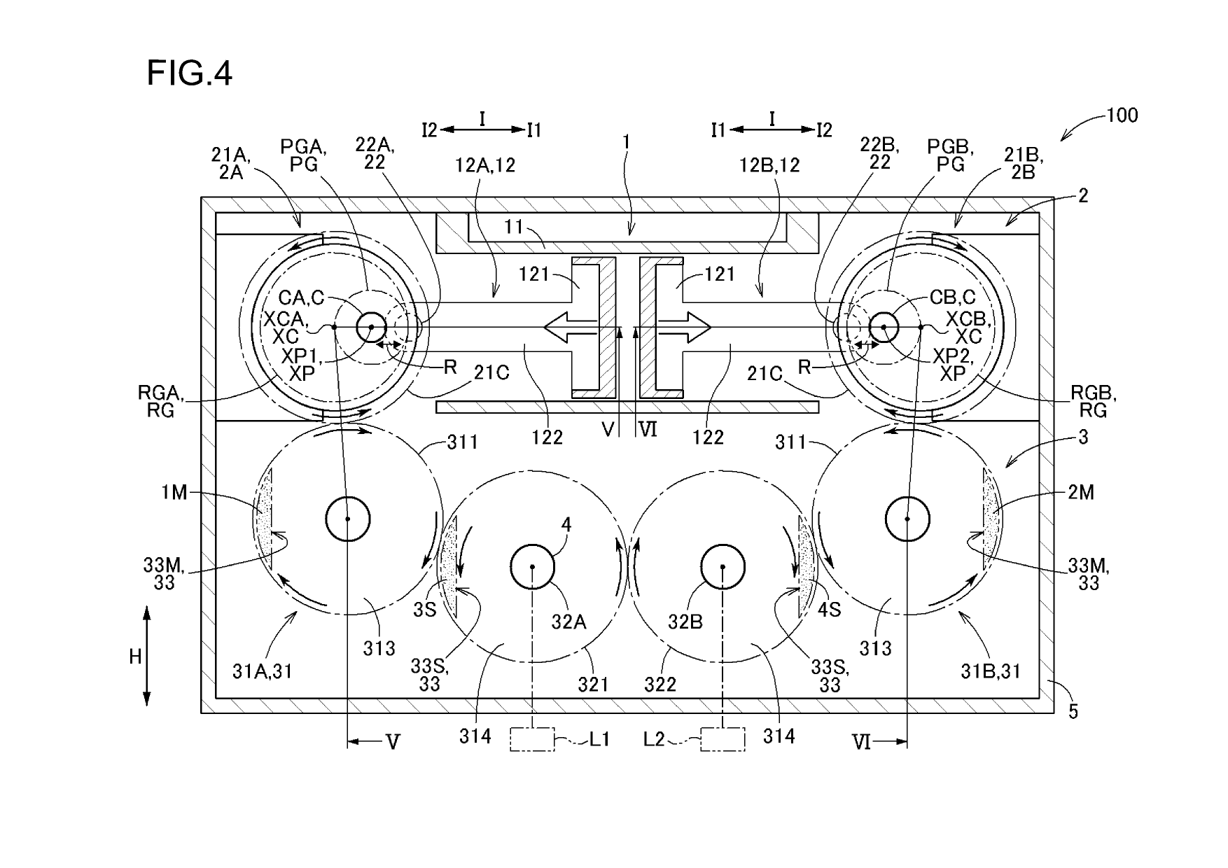

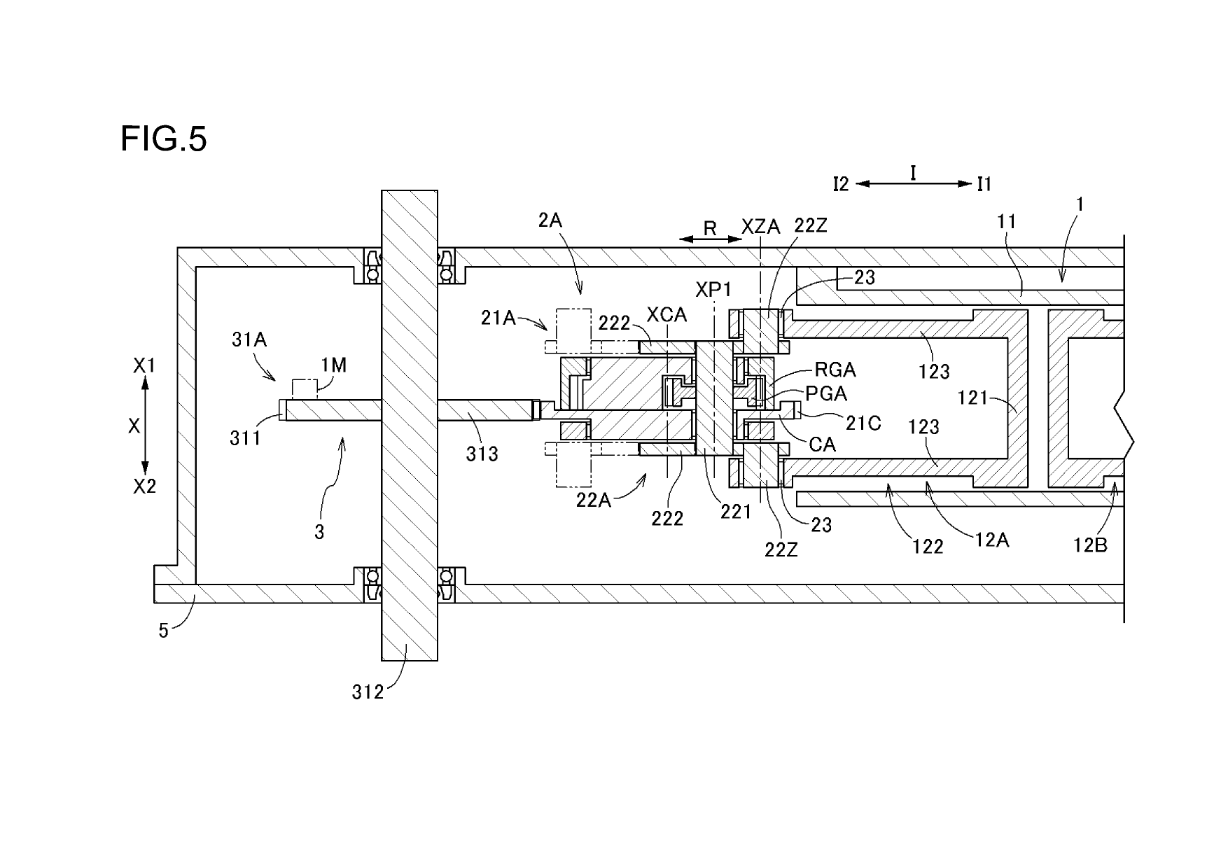

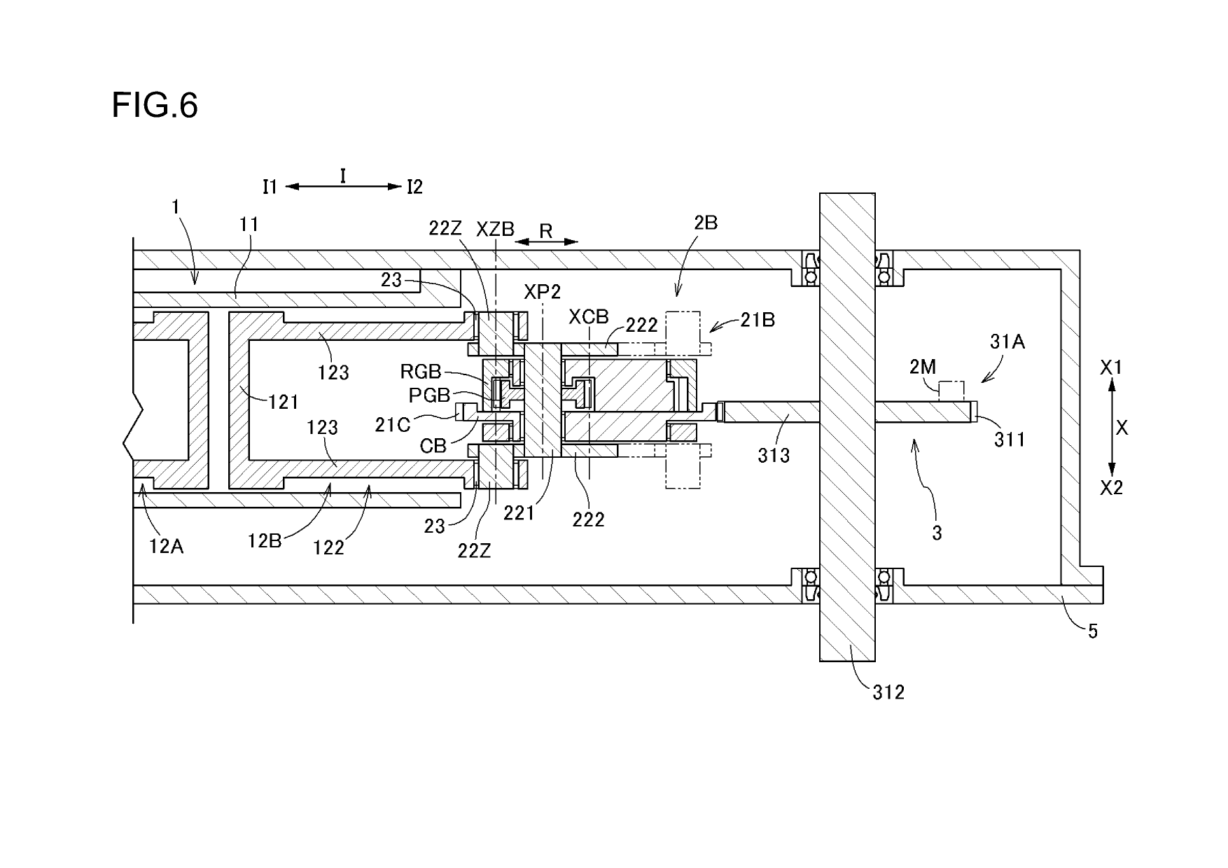

A reciprocating internal combustion engine 100 according to Embodiment 2 is described with reference to FIGS. 4 to 6. A vibration reduction structure 3 in the reciprocating internal combustion engine 100 according to Embodiment 2 differs from that in the reciprocating internal combustion engine 100 according to Embodiment 1. In the following description, only the differences between the reciprocating internal combustion engine 100 according to Embodiment 2 and the reciprocating internal combustion engine 100 according to Embodiment 1 are described. Then, description of the configuration of the reciprocating internal combustion engine 100 according to Embodiment 2 that is the same as that of the reciprocating internal combustion engine 100 according to Embodiment 1 is omitted.

In the vibration reduction structure 3 in this embodiment, a counterrotating member 31 includes a sub-wheel 314 rotating in interlocking relation with a wheel 313, in addition to the configuration described in Embodiment 1, as illustrated in FIG. 4. Then, a main balancer 33M is provided on the wheel 313 instead of a carrier C, and a counterbalancer 33S is provided on the sub-wheel 314 instead of the wheel 313, unlike Embodiment 1. Further, this embodiment also differs from Embodiment 1 in that an interlocking mechanism 32 does not include a driving gear 323 and that a first driven gear 321 and a second driven gear 322 engage directly with each other.

The sub-wheel 314 is a rotating body rotating in the opposite direction to the wheel 313. As illustrated in FIG. 4, the sub-wheel 314 included in a first counterrotating member 31A is disposed on a reciprocating-direction inner side I1 relative to the wheel 313 included in the first counterrotating member 31A. Then, the sub-wheel 314 included in the first counterrotating member 31A includes a first driven gear 321 engaging with an input portion 311 which is an external gear formed on the wheel 313. Similarly, the sub-wheel 314 included in a second counterrotating member 31B is disposed on the reciprocating-direction inner side I1 relative to the wheel 313 included in the second counterrotating member 31B. Then, the sub-wheel 314 included in the second counterrotating member 31B includes the second driven gear 322 engaging with the input portion 311 which is an external gear formed on the wheel 313. According to this configuration, a second carrier CB rotates in the opposite direction to a first carrier CA. Consequently, a couple generated by a first piston member 12A and a first power conversion unit 2A can be offset by a couple generated by a second piston member 12B and a second power conversion unit 2B. As a result, vibration generated in the entire reciprocating internal combustion engine 100 can be reduced.

The first balance weight 1M is provided on the wheel 313 in such a way as to rotate in a positional phase relationship opposite to that of the first planetary gear PGA. Specifically, the first balance weight 1M in a rotated state is disposed in such a way that the difference between the aforementioned second inclination angle (not illustrated) determined by the center of gravity position of the first balance weight 1M and a fifth inclination angle (not illustrated) determined by the center of gravity position of the first planetary gear PGA is 180°. As described above, the second inclination angle is an angle formed, when viewed in an axial direction X, between a reference line along a reciprocating direction I passing through the rotating shaft center of the first balance weight 1M and an inclined line connecting the rotating shaft center to the center of gravity position of the first balance weight 1M. The fifth inclination angle is an angle formed between a reference line along the reciprocating direction I passing through a first carrier shaft center XCA and an inclined line connecting the first carrier shaft center XCA to the center of gravity position of the first planetary gear PGA. The second balance weight 2M is provided on the wheel 313 in such a way as to rotate in a positional phase relationship opposite to that of a second planetary gear PGB, similarly to the first balance weight 1M.

In this embodiment, a first driven shaft 32A rotatably supporting the first driven gear 321 within a case 5 rotates integrally with an output member 4. Then, a first load L1 is drive-connected to the first driven gear 321. On the other hand, a torque balancer 33T is drive-connected to the second driven gear 322. In the example illustrated in FIG. 4, the torque balancer 33T is drive-connected to a second driven shaft 32B rotatably supporting the second driven gear 322 within the case 5. Then, the torque balancer 33T is a second load L2. According to this configuration, the first load L1, and the second load L2 or a fifth balance weight 5T can be arranged close to each other, and therefore, the entire configuration of the reciprocating internal combustion engine 100 can be easily simplified.

### Embodiment 3

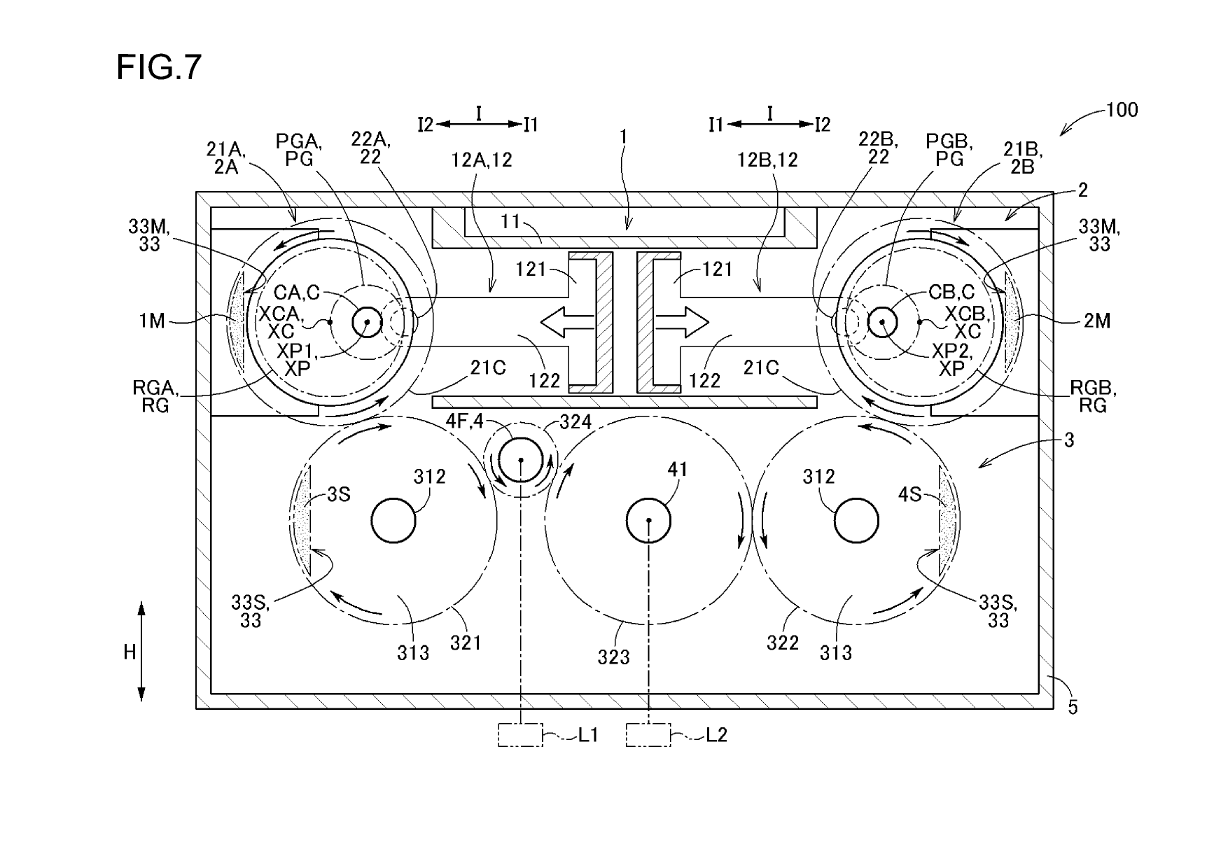

A reciprocating internal combustion engine 100 according to Embodiment 3 is described with reference to FIG. 7. An interlocking mechanism 32 in the reciprocating internal combustion engine 100 according to Embodiment 3 differs from that in the reciprocating internal combustion engine 100 according to Embodiment 1. In the following description, only the differences between the reciprocating internal combustion engine 100 according to Embodiment 3 and the reciprocating internal combustion engine 100 according to Embodiment 1 are described. Then, description of the configuration of the reciprocating internal combustion engine 100 according to Embodiment 3 that is the same as that of the reciprocating internal combustion engine 100 according to Embodiment 1 is omitted.

In the interlocking mechanism 32 in this embodiment, a driving gear 323 does not engage with a first driven gear 321, unlike Embodiment 1. Then, the interlocking mechanism 32 includes a speed-increasing gear 324 engaging with both the first driven gear 321 and the driving gear 323, in addition to the configuration described in Embodiment 1. The speed-increasing gear 324 is a gear with a pitch circle diameter smaller than that of the driving gear 323, the first driven gear 321, and a second driven gear 322. In this embodiment, the speed-increasing gear 324 includes a speed-increasing gear shaft 4F rotatably supported by the case 5, and the speed-increasing gear shaft 4F rotates integrally with an output member 4. According to this configuration, a load requiring input of high-speed rotation may be set as a first load L1. In the example illustrated in FIG. 7, the speed-increasing gear 324 is disposed at a position closer to a cylinder 11 in a cylinder radial direction H relative to a countershaft 312 included in a first counterrotating member 31A and the rotating shaft center of the driving gear 323. According to this configuration, the entire reciprocating internal combustion engine 100 can be easily downsized as well when the interlocking mechanism 32 is configured to include the speed-increasing gear 324.

Further, in this embodiment, a torque balancer 33T is drive-connected to a driving gear shaft 41. In the example illustrated in FIG. 7, the torque balancer 33T is a second load L2. According to this configuration, the first load L1 and the second load L2 can be arranged close to each other, and therefore, the space occupied by the reciprocating internal combustion engine 100 and the surrounding structure thereof can be easily reduced.

### Embodiment 4

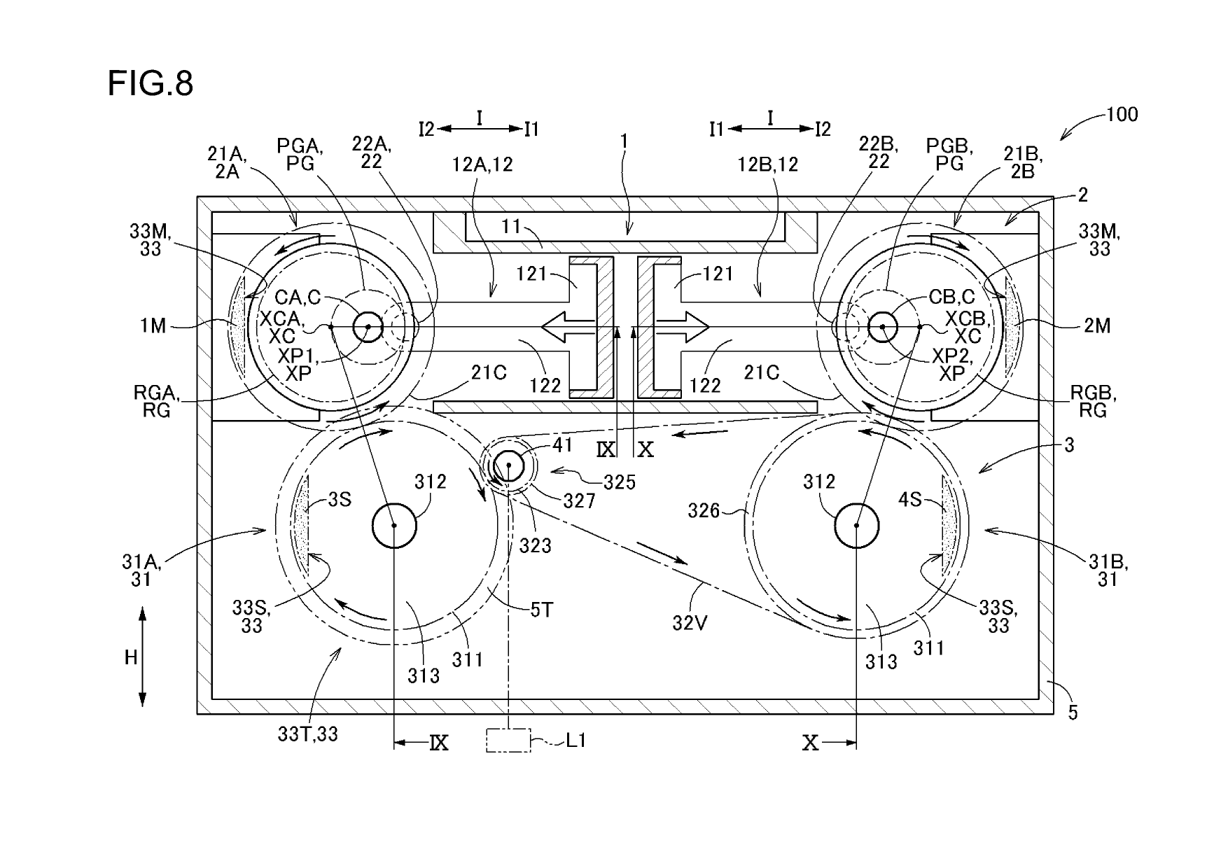

A reciprocating internal combustion engine 100 according to Embodiment 4 is described with reference to FIGS. 8 to 10. An interlocking mechanism 32 in the reciprocating internal combustion engine 100 according to Embodiment 4 differs from that in the reciprocating internal combustion engine 100 according to Embodiment 1. In the following description, only the differences between the reciprocating internal combustion engine 100 according to Embodiment 4 and the reciprocating internal combustion engine 100 according to Embodiment 1 are described. Then, description of the configuration of the reciprocating internal combustion engine 100 according to Embodiment 4 that is the same as that of the reciprocating internal combustion engine 100 according to Embodiment 1 is omitted.

In this embodiment, the interlocking mechanism 32 differs from that according to Embodiment 1 in including a belt mechanism 325 circulating along a circulation path in place of the first driven gear 321 and the second driven gear 322 described in Embodiment 1. In addition, the interlocking mechanism 32 according to Embodiment 3 differs from that according to Embodiment 1 in that a driving gear 323 engages with an input portion 311 included in a first counterrotating member 31A.

The belt mechanism 325 includes an endless belt 32V disposed along the circulation path, a first sprocket 326 rotatably supported by a case 5, and a second sprocket 327 rotatably supported by the case 5. The belt 32V is supported by both the first sprocket 326 and the second sprocket 327 in such a way as to circulate along the circulation path in interlocking relation with the rotation of each of the first sprocket 326 and the second sprocket 327. In this embodiment, the belt 32V is wound around each of the first sprocket 326 and the second sprocket 327.

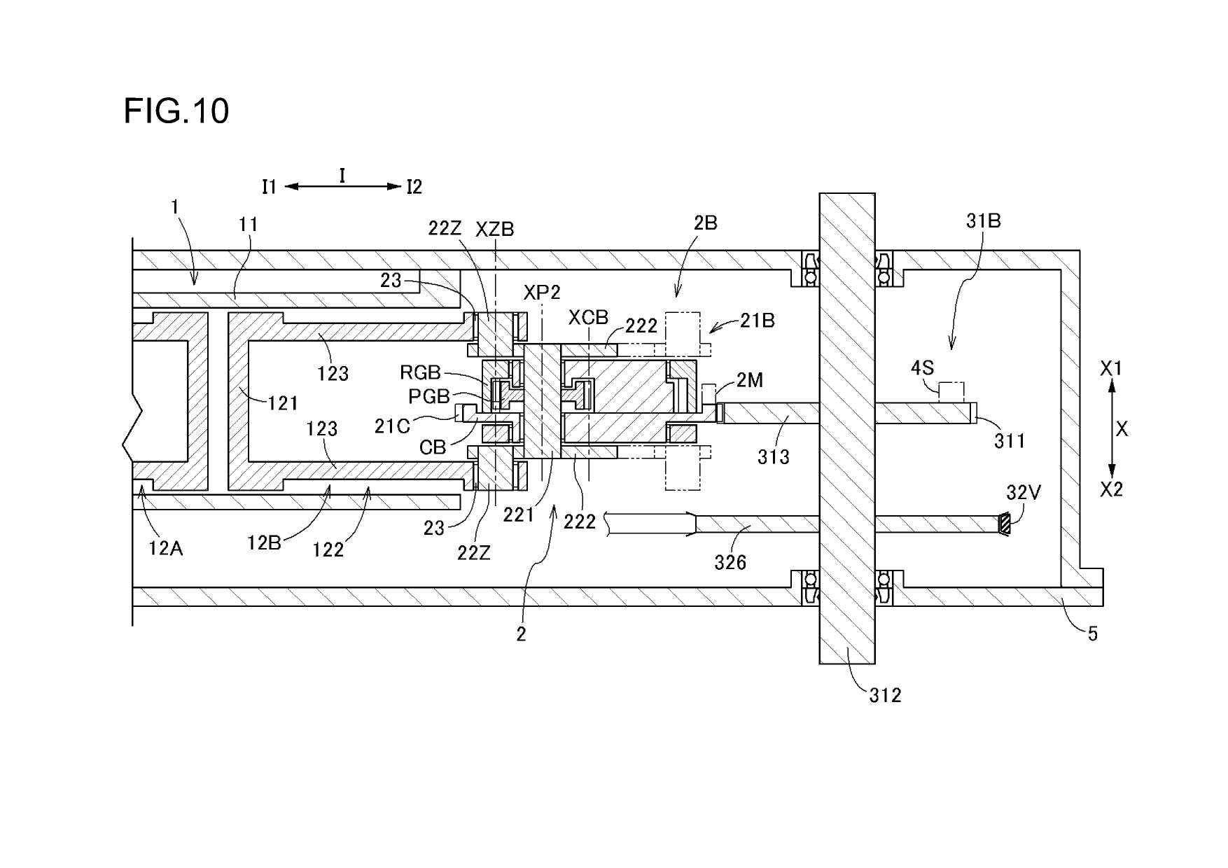

The first sprocket 326 rotates integrally with a countershaft 312 included in a second counterrotating member 31B, as illustrated in FIG. 8. Specifically, the first sprocket 326 has the same rotating shaft center as the countershaft 312 and is disposed on a second axial side X2 relative to a wheel 313, as illustrated in FIG. 10. According to this configuration, when the countershaft 312 included in the second counterrotating member 31B rotates, the first sprocket 326 rotating integrally with the countershaft 312 also rotates, and the belt 32V circulates along the circulation path.

On the other hand, the second sprocket 327 is disposed at a position closer to a cylinder 11 in a cylinder radial direction H relative to the countershaft 312 included in the first counterrotating member 31A, as illustrated in FIG. 8. The second sprocket 327 rotates together with the driving gear 323 engaging with the input portion 311 which is an external gear included in the first counterrotating member 31A. Accordingly, when the input portion 311 rotates, the driving gear 323 and the second sprocket 327 also rotate, and the belt 32V circulates along the circulation path. According to this configuration, a simple structure with a minimal number of components can cause the first counterrotating member 31A and the second counterrotating member 31B to rotate in interlocking relation with each other even when the first counterrotating member 31A and the second counterrotating member 31B are arranged at positions apart from each other in a reciprocating direction I.

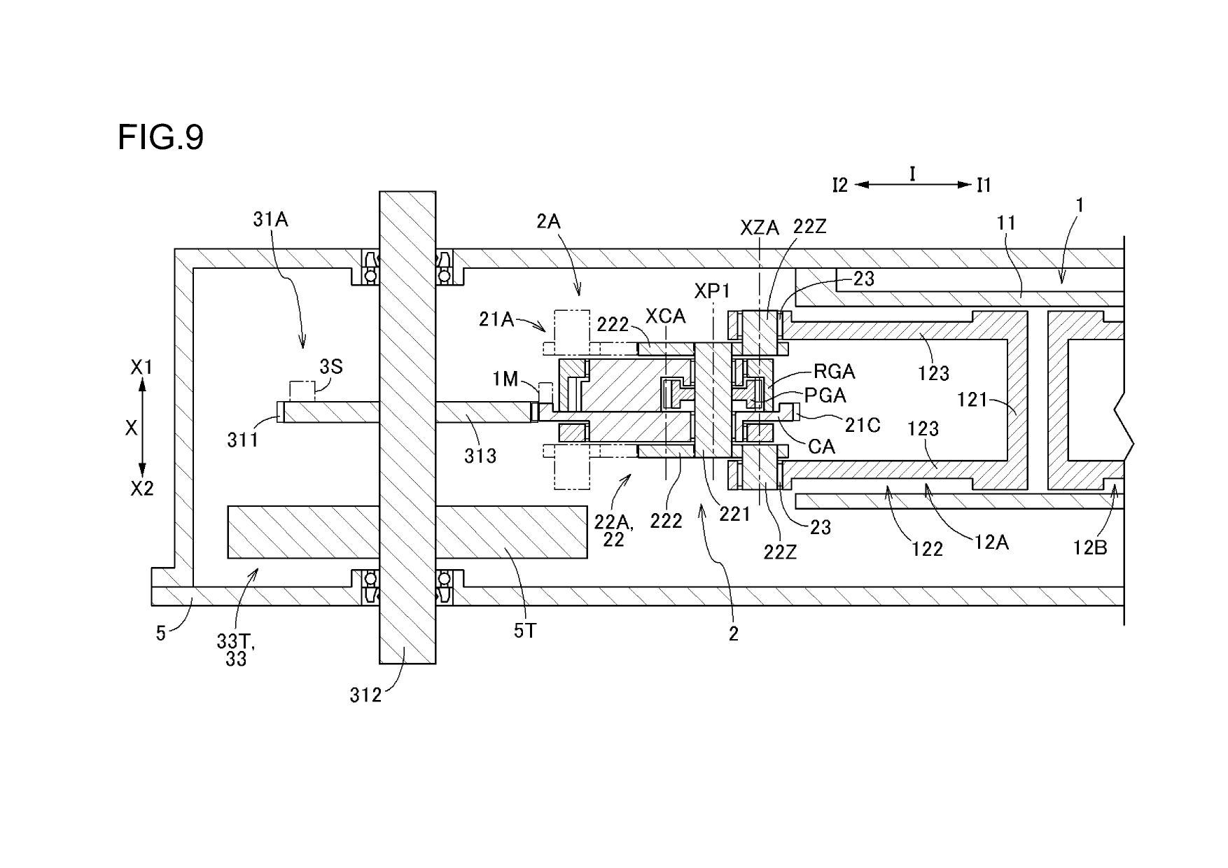

Furthermore, in this embodiment, a driving gear shaft 41 rotates integrally with an output member 4, and a torque balancer 33T is provided on the countershaft 312 included in the first counterrotating member 31A. Specifically, a first load L1 is drive-connected to the driving gear shaft 41 illustrated in FIG. 8. Then, the torque balancer 33T illustrated in FIGS. 8 and 9 is a fifth balance weight 5T. The fifth balance weight 5T illustrated in FIG. 9 is a disk being disposed on the second axial side X2 relative to the input portion 311 and having the same rotating shaft center as the countershaft 312. In the example illustrated in FIG. 9, the fifth balance weight 5T is formed integrally with the countershaft 312.

### Embodiment 5

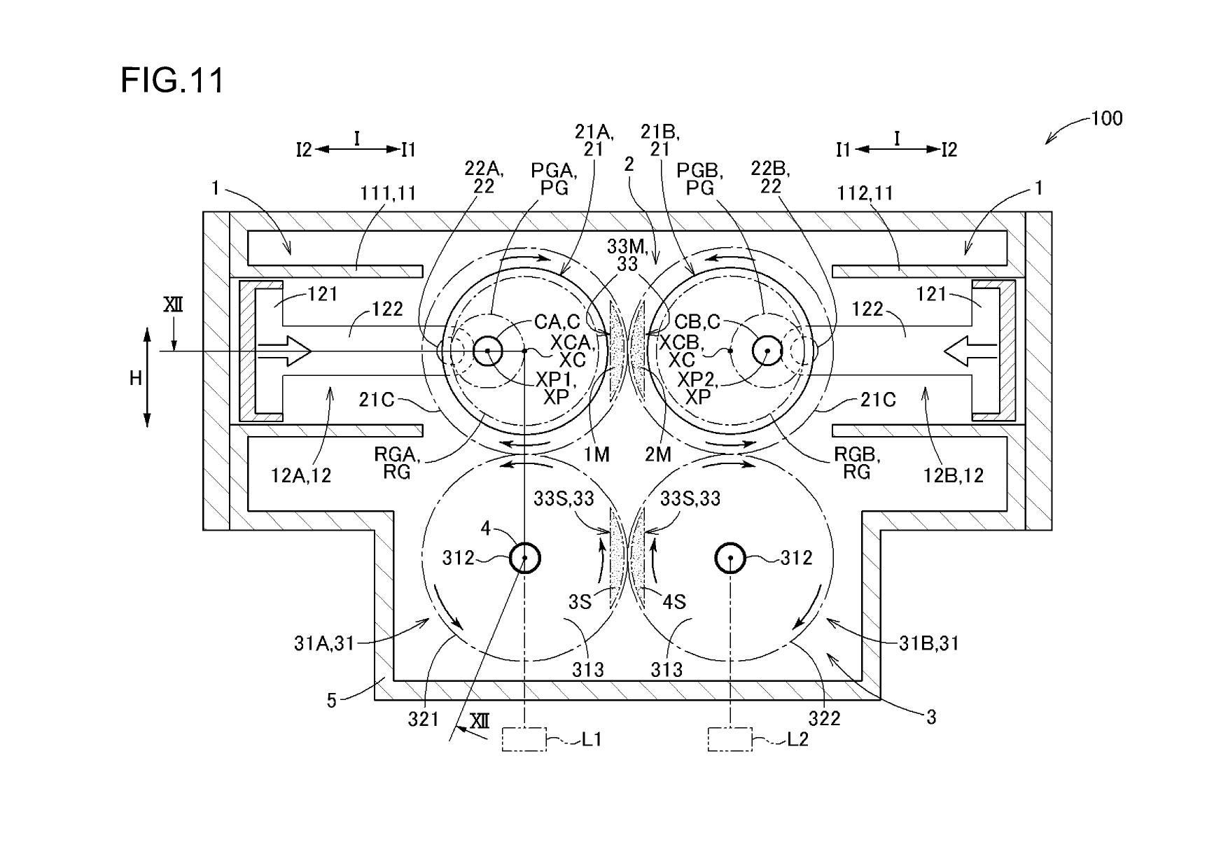

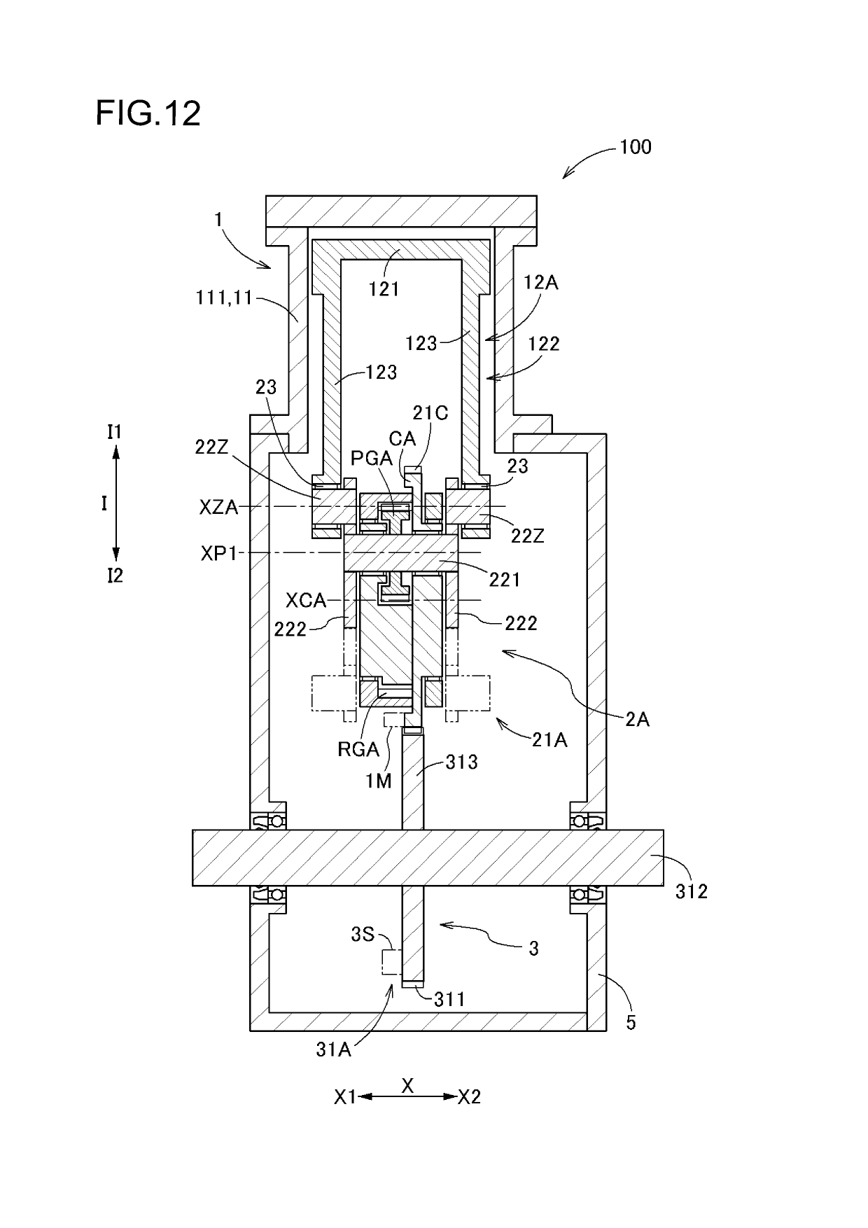

A reciprocating internal combustion engine 100 according to Embodiment 5 is described with reference to FIGS. 11 and 12. The reciprocating internal combustion engine 100 according to Embodiment 5 differs from the reciprocating internal combustion engine 100 according to Embodiment 1 in that a first piston member 12A and a second piston member 12B included in a reciprocating unit 1 slide within different cylinders 11, respectively. In the following description, only the differences between the reciprocating internal combustion engine 100 according to Embodiment 5 and the reciprocating internal combustion engine 100 according to Embodiment 1 are described. Then, description of the configuration of the reciprocating internal combustion engine 100 according to Embodiment 5 that is the same as that of the reciprocating internal combustion engine 100 according to Embodiment 1 is omitted.

In this embodiment, the reciprocating unit 1 differs from that according to Embodiment 1 in that the cylinder 11 includes a first cylinder 111 and a second cylinder 112. Each of the first cylinder 111 and the second cylinder 112 is a bottomed cylindrical wall including a wall surrounding the outer periphery of a combustion chamber and one end of the combustion chamber in a reciprocating direction I. The first piston member 12A forms the combustion chamber by covering the opening of the first cylinder 111 and reciprocates along the longitudinal direction of the first cylinder 111. Similarly, the second piston member 12B forms the combustion chamber by covering the opening of the second cylinder 112 and reciprocates along the longitudinal direction of the second cylinder 112.

In this embodiment, the first piston member 12A and the second piston member 12B are arranged in a horizontally opposed configuration. Specifically, the first piston member 12A and the second piston member 12B are arranged in such a way as to reciprocate along the same axis. Then, the first cylinder 111 and the first piston member 12A, a first power conversion unit 2A, a second power conversion unit 2B, and the second piston member 12B and the second cylinder 112 are arranged in the described order along the reciprocating direction I.

In this embodiment, a counterrotating member 31 is disposed at a position adjacent to a power conversion unit 2 in a cylinder radial direction H. In addition, unlike Embodiment 1, an interlocking mechanism 32 does not include a driving gear 323, and a first driven gear 321 and a second driven gear 322 directly engage with each other. According to this configuration, a second carrier CB rotates in the opposite direction to a first carrier CA. Accordingly, a couple generated by the first piston member 12A and the first power conversion unit 2A can be offset by a couple generated by the second piston member 12B and the second power conversion unit 2B. As a result, vibration generated in the entire reciprocating internal combustion engine 100 can be reduced. Further, according to this configuration, the interlocking mechanism 32 can be configured without including the driving gear 323, and therefore, the entire reciprocating internal combustion engine 100 can be easily downsized.

It is preferable that one of a countershaft 312 rotating together with the first driven gear 321 and a countershaft 312 rotating together with the second driven gear 322 rotate integrally with an output member 4 and the other be drive-connected to a torque balancer 33T. According to this configuration, torque fluctuations generated in the combustion chamber of each of the first cylinder 111 and the second cylinder 112 can be effectively reduced in a small space. In the example illustrated in FIG. 11, the countershaft 312 rotating together with the first driven gear 321 rotates integrally with the output member 4. On the other hand, the countershaft 312 rotating together with the second driven gear 322 is drive-connected to a second load L2.

### Embodiment 6

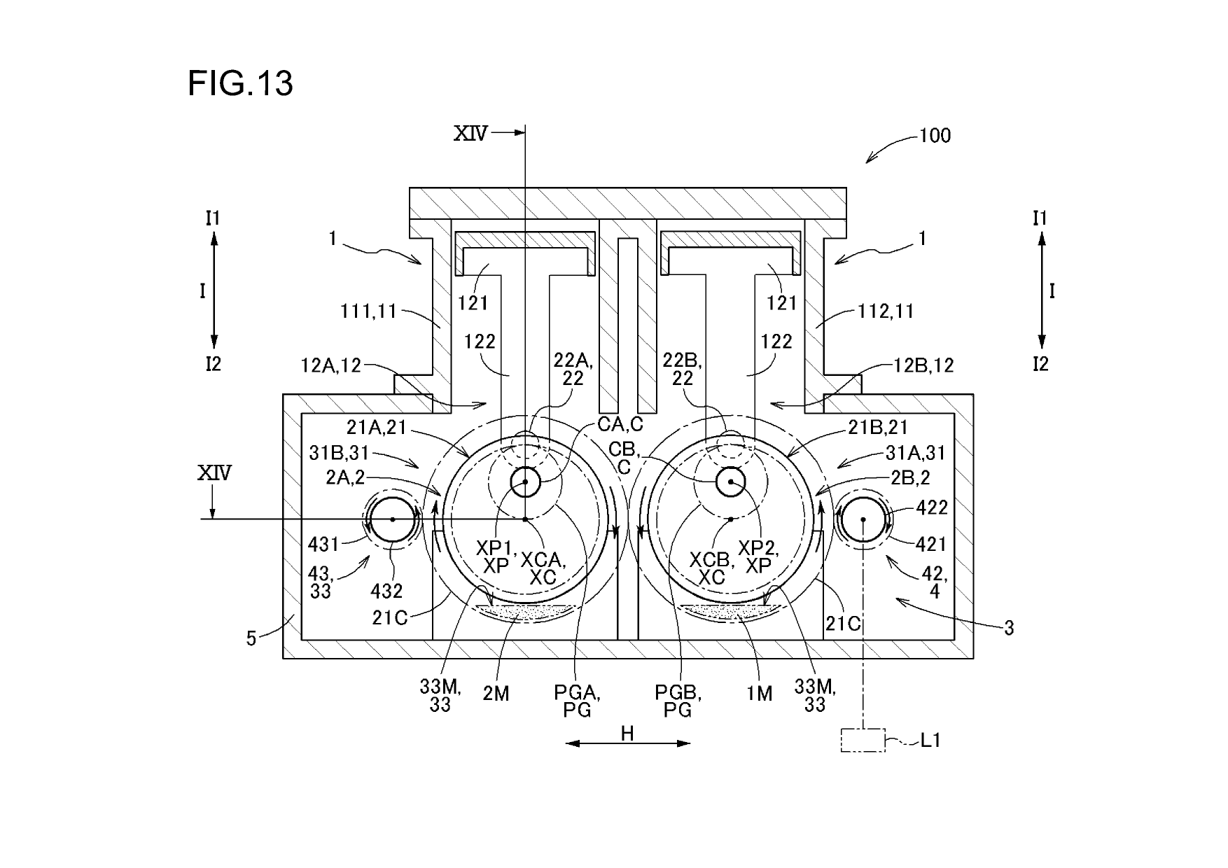

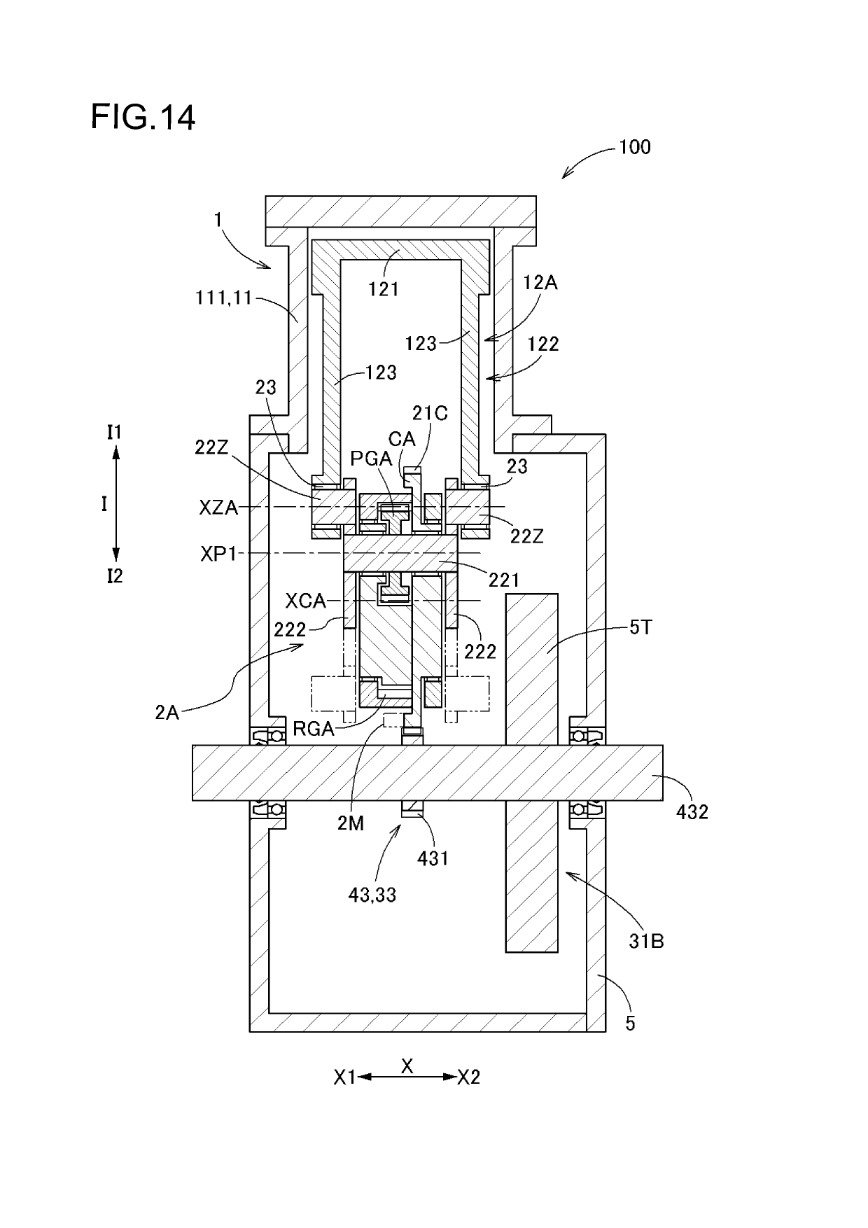

A reciprocating internal combustion engine 100 according to Embodiment 6 is described with reference to FIGS. 13 and 14. The reciprocating internal combustion engine 100 according to Embodiment 6 differs from the reciprocating internal combustion engine 100 according to Embodiment 5 in the arrangement relationship between a first cylinder 111 and a second cylinder 112. In the following description, only the differences between the reciprocating internal combustion engine 100 according to Embodiment 6 and the reciprocating internal combustion engine 100 according to Embodiment 5 are described. Then, description of the configuration of the reciprocating internal combustion engine 100 according to Embodiment 6 that is the same as that of the reciprocating internal combustion engine 100 according to Embodiment 5 is omitted.

In this embodiment, a first piston member 12A is disposed at a position adjacent to a second piston member 12B in a cylinder radial direction H. The first piston member 12A and the first cylinder 111 that are illustrated in FIG. 13 are arranged in such a way that the reciprocating path of the first piston member 12A is parallel to the reciprocating path of the second piston member 12B.

Further, in this embodiment, a first counterrotating member 31A is connected to a second carrier CB in such a way as to rotate integrally with the second carrier CB, and a second counterrotating member 31B is connected to a first carrier CA in such a way as to rotate integrally with the first carrier CA. In the example illustrated in FIG. 13, the second carrier CB also serves as the first counterrotating member 31A, and the first carrier CA serves as the second counterrotating member 31B. According to this configuration, the counterrotating members 31 constitute a part of a planetary gear mechanism 21, and therefore, the entire reciprocating internal combustion engine 100 can be easily downsized.

In this embodiment, an interlocking mechanism 32 is configured by engagement of an output portion 21C which is an external gear included in the first carrier CA with an output portion 21C which is an external gear included in the second carrier CB. Then, the number of teeth and the pitch circle diameter of the output portion 21C included in the first carrier CA are set to be the same as the number of teeth and the pitch circle diameter of the output portion 21C included in the second carrier CB. Consequently, the first carrier CA rotates in interlocking relation with the rotation of the second carrier CB at the same speed in the opposite direction to the rotation of the second carrier CB. According to this configuration, the interlocking mechanism 32 also serves as the counterrotating member 31 and constitutes a part of the planetary gear mechanism 21, and therefore, the entire reciprocating internal combustion engine 100 can be easily downsized.

In this embodiment, an output member 4 includes an output gear 421 engaging with a gear serving as the output portion 21C included in the second carrier CB and an output shaft 422 rotatably supporting the output gear 421 within a case 5. The output gear 421 is disposed on the opposite side of the first carrier CA relative to a second carrier shaft center XCB in the cylinder radial direction H. Then, a first load L1 is drive-connected to the output shaft 422.

In this embodiment, a balancer 33 further includes a torque balance member 43 rotating in the opposite direction to the output member 4. The torque balance member 43 rotates in interlocking relation with the first carrier CA. Specifically, the torque balance member 43 includes a torque balance gear 431 engaging with a gear serving as the output portion 21C included in the first carrier CA and a torque balance shaft 432 rotatably supporting the torque balance gear 431 within the case 5. The torque balance shaft 432 is disposed on the opposite side of the second carrier CB relative to a first carrier shaft center XCA in the cylinder radial direction H. A fifth balance weight 5T or a second load L2 rotates together with the torque balance shaft 432. According to this configuration, a structure that can reduce vibration caused by torque fluctuations generated in the reciprocating unit 1 can be easily implemented with a small size.

In the example illustrated in FIG. 14, a torque balancer 33T is the fifth balance weight 5T. The fifth balance weight 5T is disposed at a position spaced apart from the torque balance gear 431 rotating integrally with the torque balance shaft 432 on a second axial side X2. Then, the fifth balance weight 5T has the same rotating shaft center as the torque balance shaft 432 and rotates integrally with the torque balance shaft 432.

### Other Embodiments

Next, other embodiments of the reciprocating internal combustion engine 100 are described.

(1) The reciprocating unit 1 has been described to include the first piston member 12A and the second piston member 12B in the aforementioned embodiments. However, the number of piston members 12 may be two or greater.

(2) The output portion 21C has been described to be an external gear in the aforementioned embodiments. However, the output portion 21C is not limited to an external gear as long as the portion can output rotary motion. For example, the output portion 21C may be an internal gear or may be a belt or a chain.

(3) The first piston member 12A and the first cylinder 111 are arranged in such a way that the reciprocating path of the first piston member 12A is parallel to the reciprocating path of the second piston member 12B in the aforementioned embodiment 6. However, the first piston member 12A and the first cylinder 111 may be arranged in such a way that the reciprocating path of the first piston member 12A intersects the reciprocating path of the second piston member 12B in two-dimensions or three dimensions.

(4) Note that a configuration disclosed in an embodiment described above may be applied in combination with a configuration disclosed in another embodiment without contradicting each other. Regarding other configurations, the embodiments disclosed in this disclosure are merely exemplary in all aspects. Accordingly, various modifications may be made as appropriate without departing from the spirit of this disclosure.

### Summary of Embodiments

The following is a summary of the embodiments related to the reciprocating internal combustion engine (100) described above.

A reciprocating internal combustion engine (100) includes: a first planetary gear mechanism (21A) including a first ring gear (RGA) being an internal gear, a first carrier (CA) being rotatably supported relative to the first ring gear (RGA), and a first planetary gear (PGA) being rotatably supported relative to the first carrier (CA) and engaging with the first ring gear (RGA); a first crank member (22A) being connected to the first planetary gear in such a way as to rotate integrally with the first planetary gear (PGA); a first piston member (12A) being connected to the first crank member (22A) in such a way as to rotatable relative to the first crank member (22A) around a first input shaft center (XZA) being set at a position separated from a first planetary shaft center (XP1) being a rotating shaft center of the first planetary gear (PGA); a first counterrotating member (31A) rotating in the opposite direction to the first carrier (CA) at the same speed in interlocking relation with rotation of the first carrier (CA); a second planetary gear mechanism (21B) including a second ring gear (RG) being an internal gear, a second carrier (CB) being rotatably supported relative to the second ring gear (RG), and a second planetary gear (PGB) being rotatably supported relative to the second carrier (CB) and engaging with the second ring gear (RG); a second crank member (22B) being connected to the second planetary gear in such a way as to rotate integrally with the second planetary gear (PGB); a second piston member (12B) being connected to the second crank member (22B) in such a way as to be rotatable relative to the second crank member (22B) around a second input shaft center (XZB) being set at a position separated from a second planetary shaft center (XP2) being a rotating shaft center of the second planetary gear (PGB); a second counterrotating member (31B) rotating in the opposite direction to the second carrier (CB) at the same speed in interlocking relation with rotation of the second carrier (CB); an interlocking mechanism (32) causing the first counterrotating member (31A) and the second counterrotating member (31B) to interlock with each other in such a way that the first counterrotating member (31A) and the second counterrotating member (31B) rotate at the same speed; and an output member (4) rotating in interlocking relation with the first carrier (CA), the second carrier (CB), the first counterrotating member (31A), the second counterrotating member (31B), and the interlocking mechanism (32).

According to this configuration, the reciprocating motion of the first piston member (12A) and the second piston member (12B) is converted into rotary motion by the planetary gear mechanism (21) in which the difference in speed variation of the piston between the forward stroke and the return stroke is smaller than that in the crank mechanism, and therefore, secondary vibration can be easily minimized. Further, the primary vibration generated by the reciprocating motion of the first piston member (12A) and the second piston member (12B) can be effectively reduced by the first counterrotating member (31A) and the second counterrotating member (31B). Accordingly, the vibration generated by the entire reciprocating internal combustion engine (100) can be easily reduced.

The reciprocating internal combustion engine (100) may further include: a first balance weight (1M) rotating in the same direction as the first carrier (CA); a second balance weight (2M) rotating in the same direction as the second carrier (CB); a third balance weight (3S) rotating in the same direction as the first counterrotating member (31A); a fourth balance weight (4S) rotating in the same direction as the second counterrotating member (31B); and a fifth balance weight (5T) or a second load (L2) having the same moment of inertia as a moment of inertia of a first load (L1) connected to the output member (4), in which the fifth balance weight (5T) or the second load (L2) may rotate in the opposite direction to the output member (4).

According to this configuration, the first load (L1), the first balance weight (1M), the second balance weight (2M), the third balance weight (3S), the fourth balance weight (4S), and the fifth balance weight (5T) or the second load (L2) reduce primary vibration and effectively absorb torque fluctuations to be generated during the combustion cycle.

In the reciprocating internal combustion engine (100), a first rotating shaft center (XCA) being a rotating shaft center of the first carrier (CA) and a second rotating shaft center (XCB) being a rotating shaft center of the second carrier (CB) may be arranged parallel to each other, and, assuming a direction along the first rotating shaft center (XCA) and the second rotating shaft center (XCB) to be an axial direction (X) and an imaginary line connecting the first rotating shaft center (XCA) and the second rotating shaft center (XCB) when viewed in the axial direction (X) to be a reference axis, the first piston member (12A) and the second piston member (12B) may be arranged opposite to each other in such a way as to reciprocate along the reference axis.

According to this configuration, the first planetary gear (PGA) connected to the first piston member (12A) rotates in the opposite direction to the second planetary gear (PGB) connected to the second piston member (12B). Accordingly, vibration caused by a couple generated in the entire reciprocating internal combustion engine (100) can be easily reduced.

In the reciprocating internal combustion engine (100), a first rotating shaft center (XCA) being a rotating shaft center of the first carrier (CA) and a second rotating shaft center (XCB) being a rotating shaft center of the second carrier (CB) may be arranged parallel to each other, the first counterrotating member (31A) may be connected to the second carrier (CB) in such a way as to rotate integrally with the second carrier (CB), and the second counterrotating member (31B) may be connected to the first carrier (CA) in such a way as to rotate integrally with the first carrier (CA).

According to this configuration, the first counterrotating member (31A) is connected to the second carrier (CB) in such a way as to rotate integrally with the second carrier (CB), and therefore, the first counterrotating member (31A) and the second carrier (CB) can be arranged coaxially; and the second counterrotating member (31B) is connected to the first carrier (CA) in such a way as to rotate integrally with the first carrier (CA), and therefore, the second counterrotating member (31B) and the first carrier (CA) can be arranged coaxially. Therefore, downsizing and simplification of the mechanisms can be easily achieved.

### Industrial Applicability

The technique related to this disclosure can be utilized in reciprocating internal combustion engines.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A reciprocating internal combustion engine comprising:
a first planetary gear mechanism including a first ring gear being an internal gear, a first carrier being rotatably supported relative to the first ring gear, and a first planetary gear being rotatably supported relative to the first carrier and engaging with the first ring gear;
a first crank member being connected to the first planetary gear in such a way as to rotate integrally with the first planetary gear;
a first piston member being connected to the first crank member in such a way as to be rotatable relative to the first crank member around a first input shaft center being set at a position separated from a first planetary shaft center being a rotating shaft center of the first planetary gear;
a first counterrotating member rotating in an opposite direction to the first carrier at a same speed in interlocking relation with rotation of the first carrier;
a second planetary gear mechanism including a second ring gear being an internal gear, a second carrier being rotatably supported relative to the second ring gear, and a second planetary gear being rotatably supported relative to the second carrier and engaging with the second ring gear;
a second crank member being connected to the second planetary gear in such a way as to rotate integrally with the second planetary gear;
a second piston member being connected to the second crank member in such a way as to be rotatable relative to the second crank member around a second input shaft center being set at a position separated from a second planetary shaft center being a rotating shaft center of the second planetary gear;
a second counterrotating member rotating in an opposite direction to the second carrier at a same speed in interlocking relation with rotation of the second carrier;
an interlocking mechanism causing the first counterrotating member and the second counterrotating member to interlock with each other in such a way that the first counterrotating member and the second counterrotating member rotate at a same speed; and
an output member rotating in interlocking relation with the first carrier, the second carrier, the first counterrotating member, the second counterrotating member, and the interlocking mechanism.

2. The reciprocating internal combustion engine according to claim 1, further comprising:
a first balance weight rotating in a same direction as the first carrier;
a second balance weight rotating in a same direction as the second carrier;
a third balance weight rotating in a same direction as the first counterrotating member;
a fourth balance weight rotating in a same direction as the second counterrotating member; and
a fifth balance weight or a second load having a same moment of inertia as a moment of inertia of a first load connected to the output member, wherein
the fifth balance weight or the second load rotates in an opposite direction to the output member.

3. The reciprocating internal combustion engine according to claim 1, wherein
a first rotating shaft center being a rotating shaft center of the first carrier and a second rotating shaft center being a rotating shaft center of the second carrier are arranged parallel to each other, and,
assuming a direction along the first rotating shaft center and the second rotating shaft center to be an axial direction and an imaginary line connecting the first rotating shaft center and the second rotating shaft center when viewed in the axial direction to be a reference axis,
the first piston member and the second piston member are arranged opposite to each other in such a way as to reciprocate along the reference axis.

4. The reciprocating internal combustion engine according to claim 1, wherein
a first rotating shaft center being a rotating shaft center of the first carrier and a second rotating shaft center being a rotating shaft center of the second carrier are arranged parallel to each other,
the first counterrotating member is connected to the second carrier in such a way as to rotate integrally with the second carrier, and
the second counterrotating member is connected to the first carrier in such a way as to rotate integrally with the first carrier.

5. The reciprocating internal combustion engine according to claim 2, wherein
a first rotating shaft center being a rotating shaft center of the first carrier and a second rotating shaft center being a rotating shaft center of the second carrier are arranged parallel to each other, and,
assuming a direction along the first rotating shaft center and the second rotating shaft center to be an axial direction and an imaginary line connecting the first rotating shaft center and the second rotating shaft center when viewed in the axial direction to be a reference axis,
the first piston member and the second piston member are arranged opposite to each other in such a way as to reciprocate along the reference axis.

6. The reciprocating internal combustion engine according to claim 2, wherein
a first rotating shaft center being a rotating shaft center of the first carrier and a second rotating shaft center being a rotating shaft center of the second carrier are arranged parallel to each other,
the first counterrotating member is connected to the second carrier in such a way as to rotate integrally with the second carrier, and
the second counterrotating member is connected to the first carrier in such a way as to rotate integrally with the first carrier.
